(19) United States
(12) Patent Application Publication
(10) Pub. No.: US 2026/0363164 A1
(43) Pub. Date: Nov. 19, 2026

(54) METHOD FOR DETECTING A TOO-SHORT MOWING LINE OF A LINE MOWER, AND LINE MOWER

(71) Applicant: Andreas Stihl AG & Co. KG, Waiblingen (DE)

(72) Inventors: Lisa Katharina Hill, Rosbach vor der Höhe (DE); Klaus Kaupp, Waiblingen (DE)

(73) Assignee: Andreas Stihl AG & Co. KG, Waiblingen (DE)

(21) Appl. No.: 19/573,111

(22) Filed: Mar. 20, 2026

(30) Foreign Application Priority Data
Mar. 28, 2025 (DE) 10 2025 112 225.3
Mar. 28, 2025 (DE) 10 2025 112 228.8
Mar. 28, 2025 (DE) 10 2025 112 229.6

(51) Int. Cl. A01D 34/00; A01D 34/416

(52) U.S. Cl. CPC A01D 34/006; A01D 34/416

(57) ABSTRACT

A method is proposed for detecting a too-short mowing line of a line mower, wherein, at a plurality of different points in time, a power of a motor of the line mower is controlled to set the mowing line into rotation for mowing and to tighten it by the rotation. An actual rotational speed is also captured. The actual rotational speed and the power of the motor are used to determine whether the mowing line is too short. Thereafter, it is checked whether, at a first minimum number of the different points in time, it was detected that the mowing line is too short, wherein the first minimum number is less than or equal to the plurality of different points in time. The proposed method allows for a more reliable detection of whether the mowing line of a line mower is too short.

### CROSS-REFERENCE TO RELATED APPLICATIONS

This application claims priority of German Patent Application No. 10 2025 112 225.3, filed Mar. 28, 2025, German Patent Application No. 10 2025 112 228.8, filed on Mar. 28, 2025, and German Patent Application No. 10 2025 112 229.6, filed Mar. 28, 2025. The disclosures of these prior applications are considered part of the disclosure of this application and are hereby incorporated by reference in their entireties.

### FIELD

The disclosure relates to methods for detecting a too-short mowing line of a line mower, and line mowers.

### BACKGROUND

Methods for detecting a too-short mowing line of a line mower, and line mowers, are known from the prior art, for example from patent specification DE 30 29 056 C2, published patent applications DE 10 2007 056 319 A1 and WO 2017/059917 A1, and patent specification EP 3 552 471 B1

### SUMMARY

The present disclosure relates to a method for detecting a too-short mowing line of a line mower. The method comprises the steps of:
controlling a power of a motor of the line mower to set the mowing line into rotation for mowing and to tighten it by the rotation;
capturing an actual rotational speed; and
determining, using the actual rotational speed and the power of the motor whether the mowing line is too short.

The method may also comprise a step in which a target rotational speed is captured. For determining whether the mowing line is too short, the target rotational speed may also be employed; i.e., the target rotational speed, the actual rotational speed, and the power of the motor may then be used to determine whether the mowing line is too short.

Accordingly, for detecting a too-short mowing line according to this method and the methods proposed below, substantially characteristic parameters of the motor are used, in particular, a target rotational speed of the motor, a captured actual rotational speed of the motor, and the power of the motor may be used. In this case, rotational speeds and powers are to be understood as quantities that are expressed as positive values. Negative values are possible, but for the sake of simplicity, they will not be explicitly considered hereinbelow. The same applies to lengths.

The target or the actual rotational speed may also be the rotational speed with which the mowing line is set into rotation by the motor. In many cases, these rotational speeds are directly related to the target and actual rotational speeds of the motor. The relationship may be simple, i.e., the target and actual rotational speeds of the mowing line are equal to the target and actual rotational speeds of the motor. The figures may also be in a specific ratio to one another, for example, when the driving force of the motor is transmitted to a gearbox, which converts the driving force of the motor into higher or lower rotational speeds of the mowing line, as appropriate. The gear ratio may be, for example, 1:2, i.e., one revolution of the motor may be converted by the gearbox into two revolutions of the mowing line. Ratios of 1:1.5, 1:3, 1:5, 2:1, 3:1, and many others are also conceivable. In many cases, any time delays that may occur during the conversion may be neglected, so that the target and actual rotational speeds of the mowing line and the target and actual rotational speeds of the motor may often be directly converted into each other using a factor for determining whether the mowing line is too short.

The line mower may be utilized, for example, to mow vegetation or plants, for example, grass of a lawn, meadow, or forest area. In this case, the power consumption of the motor or the power drawn by the motor varies depending on the type and condition of the vegetation or plants to be mowed. Further variations in power consumption or in the power drawn by the motor, arise from the use or operation of the line mower. Upon power-on or start-up, in many cases, no vegetation or plants are being mowed or cut. The same applies also when the line mower is powered off or switched off. In these cases, the line mower may be idling. Idle phases also occur during turning maneuvers or lifting processes of the line mower as intended. In particular, when the line mower is designed as a string trimmer or trimmer, mowing and idle phases may regularly follow each other or alternate in short intervals, since for mowing a string trimmer or trimmer is often moved in a sweeping motion over or along the vegetation or plants to be mowed. In this case, the time intervals between two immediately consecutive mowing phases may be just a few seconds. This also applies to the time intervals between two immediately consecutive idle phases.

When switching from a mowing to an idle phase, the load on the line mower changes due to the vegetation or plants to be mowed. During the mowing phase, the load and corresponding power consumption of the motor are generally higher than during the idle phase. Often in this case, the actual rotational speed is also lower than the captured target rotational speed. When the load is removed, such as at the turning point of a sweeping motion of a string trimmer or trimmer, in many cases, the motor is initially continued to be operated at substantially unchanged power. This may lead to a brief increase or an overshoot of the actual rotational speed above the target rotational speed. Thereafter, the power of the motor is then often automatically reduced so that the actual rotational speed returns to the target rotational speed. The return to the target rotational speed may take some time. During this time, the power consumption of the motor, or the power with which the motor is operated, may be lower than required for operation at the captured actual rotational speed in other situations or operating phases, especially under constant load or during longer idle phases.

In many cases, the actual rotational speed and the power of the motor are sufficient to conclude that a mowing line is too short. In particular during stable idle phases, following transient response of the actual rotational speed while reaching the target rotational speed, the power or power consumption of the motor depends on the length of the mowing line. A similar situation occurs under constant load. Accordingly, in these cases, it may be concluded that a mowing line is too short, if the power of the motor drops below a certain level or a predefined reference power. In this case, the reference power may be considered to be dependent on the actual rotational speed, or may depend on the actual rotational speed. In many cases, this conclusion may be drawn regardless of whether the line mower is operating in the idle phase or under load. Similarly, the actual rotational speed may be employed to determine whether the mowing line is too short. If the actual rotational speed exceeds a certain level or a predefined reference rotational speed, it may be concluded that a mowing line is too short.

In the transition situations described above, i.e., in particular during transition from operation under load to operation without load or idling, but also during power-on or start-up of the line mower, the actual rotational speed and the power of the motor may reach rotational speeds or powers that, in more stable operating phases, would be attributed to a too-short mowing line. Therefore, relying solely on these two quantities carries the risk of erroneously detecting a too-short mowing line, at least during or immediately after the transition. However, by also taking into account the target rotational speed, such transition phases may be detected. The proposed method may thus be employed to more reliably detect a too-short mowing line. No additional sensors are required. This method may be used to determine a too-short line both under pure air load, i.e., when the line mower is operating without load, and during mowing application. As a result, the mowing application may also be improved in terms of efficiency. Finally, the method enables a more reliable provision of an optimal target mowing circle diameter of the line mower.

There are several ways the target rotational speed may be employed for this purpose. For example, when determining whether the mowing line is too short, it may be checked whether the actual rotational speed is greater than the target rotational speed. If the actual rotational speed is greater than the target rotational speed, it may additionally be determined in the course of the method that it cannot be reliably detected whether the mowing line is too short. Thereafter, the method may then be repeated. If the actual rotational speed is less than or equal to the target rotational speed, it may be determined whether the mowing line is too short. It may also be checked whether the actual rotational speed exceeds the target rotational speed by a specific rotational speed. In this case, the specific rotational speed may be an absolute rotational speed, for example, 200 min⁻¹, 500 min⁻¹, or 1000 min⁻¹. It may also be a relative rotational speed dependent on the actual or target rotational speed, for example, 5%, 10% or 15% of the actual or target rotational speed. Accordingly, determining whether the mowing line is too short may therefore be reliably achieved even with minor deviations between the target and the actual rotational speeds. However, if the deviation is too large, i.e., if the actual rotational speed exceeds the target rotational speed by the specific rotational speed, it may be additionally determined, as before, that it cannot be reliably detected whether the mowing line is too short. The proposed method may also be improved in terms of efficiency by including the specific rotational speed in the check.

For example, the target rotational speed may be specified by an operator of the line mower by means of a throttle lever or any other control element, and thus captured. In this case, the throttle lever position may be captured and converted into a target rotational speed. The target rotational speed may also be specified by a cruise control function, which may be activated, for example, via a touchscreen of the line mower. In this case, the target rotational speed may be captured by retrieving the rotational speed stored in the cruise control function. Also, the target rotational speed may be stored in a memory of the line mower or calculated by a control unit of the line mower to implement a mowing program, for example. In this case, the target rotational speed may be captured by retrieving the rotational speed stored in the memory or the rotational speed calculated by the control unit.

The actual rotational speed indicates the (angular) speed at which the motor or the mowing line is rotating at a specific point in time. In this case, the specific point in time may be the point in time at which the actual rotational speed is captured. Capturing may also occur in several steps performed at different points in time. In these cases, the specific point in time may be one of these points in time. The actual rotational speed may be measured using appropriate sensors, for example one or more Hall sensors, or using optical sensors.

The power of the motor may be controlled using a rotational speed-power characteristic that assigns a power of the motor to each target rotational speed. Controlling may also be implemented using a control loop which control loop is configured to compensate for any deviation of the actual rotational speed from the target rotational speed by adjusting the power of the motor. P, D and/or I control loops, as well as combinations of such control loops, may be utilized for this purpose.

The line mower may comprise an indicator, such as an LED indicator. If it is detected in the course of the proposed method that the mowing line is too short, the indicator may be activated to signal to the operator of the line mower that the mowing line is too short. Instead of an LED indicator, other output means such as acoustic or other optical signals are also conceivable.

The line mower may also feature a mechanism for automatic line extension. If it is detected in the course of the method that the mowing line is too short, the line extension adjustment may be activated to extend the mowing line. In this case, the mowing line may be extended in stages. Extending the mowing line may also be monitored using the proposed method by repeating the method once extension adjustment of the mowing line has taken place.

The motor may be an internal combustion engine or an electric motor. In the case of electric motors, the power of the motor may also be controlled or captured via the current draw of the motor. In this case, the current draw may be employed instead of the power of the motor to execute the method just proposed and the methods proposed below. This applies, in particular, if the voltage at which the motor draws current is known or constant, or if it is measured or determined.

The methods described above and proposed below may be executed multiple times. They may be executed repeatedly in succession. In particular, the methods may be executed repeatedly at periodic intervals.

The target rotational speed may also be employed in other ways for determining whether the mowing line is too short. For example, a correction variable may be generated using the target and actual rotational speeds. In this case, the correction variable may be generated in particular using the difference or the absolute value of the difference between the target and actual rotational speeds. The correction variable may depend on this difference or absolute value, for example, in a linear fashion. In this case, the correction variable may represent the above-described overshoot of the actual rotational speed beyond the target rotational speed and the associated drop in power of the motor. Accordingly, the power may be corrected using the correction variable to determine whether the mowing line is too short. In particular, the drop in power during overshoot may be compensated for by the correction variable; i.e., the power may be corrected towards higher powers using the correction variable when determining whether the mowing line is too short. Similarly, the reference power described above may be reduced using the correction variable to prevent the erroneous determination that the mowing line is too short.

The correction variable may be a correction power, wherein the correction power is added to the power of the motor and/or subtracted from the reference power. The correction variable may also be a dimensionless factor by which the power of the motor and/or the reference power are/is multiplied.

The correction variable may be calculated as correction power, for example, as follows:

CorrPow=CorrPow₀·(1−exp(−|ActRotSp−TargRotSp|/DCorr)),

wherein the variable CorrPow represents the value of the correction power and the variable CorrPow₀ represents the maximum value of the correction power to be applied, the value of the actual rotational speed is substituted for the variable ActRotSp and the value of the target rotational speed is substituted for the variable TargRotSp, and DCorr represents a factor. The factor DCorr may, for example, assume a value of 500, 1000, or 2000 when the values of the actual and target rotational speeds in min⁻¹ are substituted for the variables ActRotSp and TargRotSp described above. The maximum value of the correction power to be applied, CorrPow₀, may, for example, be 100, 200, or 250, corresponding to a correction power of 100 W, 200 W, or 250 W. The formula provided is merely an example. Here, numerous variations and also other functional relationships are conceivable.

The transient response, or the overshoot described above, may depend on the length of the mowing line. For example, a shorter line may lead to greater overshoot in rotational speed or undershoot in power compared to a longer line. Accordingly, the correction variable may also depend on the length of the mowing line. To more reliably detect or determine whether the mowing line is too short using one of the proposed methods, the dependence of the correction variable on the length of the mowing line may be taken into account. For this purpose, the length of the mowing line may be captured, and the correction variable may be additionally generated using the length of the mowing line. In this case, the length of the mowing line may be a target length, i.e., the minimum target length the mowing line should have to avoid being considered too short or be determined to be too short, for example. Such a target length is typically assigned to the aforementioned reference power. The length of the mowing line may also be a length determined before any of the aforementioned method steps are executed. For this purpose, for example, a previous actual rotational speed and a previous power of the motor may be captured and used to calculate the length of the mowing line. In this case, the previous actual rotational speed and the previous power may each be captured or determined at a point in time prior to the point in time at which the actual rotational speed is captured and/or the power of the motor is adjusted to the actual rotational speed. In the example described above, the length dependence of the correction variable may be taken into account, for example, by a length dependence of the variable CorrPow₀, for example by:

CorrPow₀=CorrPow₀·(1−exp(−a_{LTarg}·(b_{Targ}LTarg−L))),

wherein the value of the target length of the mowing line is substituted for the variable LTarg, and the length of the mowing line determined before executing one of the aforementioned method steps is substituted for the variable L. The value of 0.01 may be substituted for the variable a_{LTarg}, for example. The value of 1.2 may be substituted for the variable b_{LTarg}, for example. In this case, the formula described above is only applied if L<(b_{LTarg} LTarg) . If the length of the mowing line determined before executing one of the aforementioned method steps is greater than or equal to the target length multiplied by the factor b_{LTarg}, then the value of the target length multiplied by the factor b_{LTarg} is substituted for the variable L.

A change in the actual rotational speed may be also detected and the change in the actual rotational speed may be taken into account when generating the correction variable and/or correcting the power. For example, if the actual rotational speed drops, the correction variable may be generated using one or more previous values for the actual rotational speed and the power of the motor. Similarly, a correction variable applied at an earlier point in time may still be employed. For example, the correction variable generated approximately 0.1 s, 0.08 s, or 0.05 s ago may still be applied. Such a time offset may prevent the correction of the power of the motor or the reference power from being prematurely terminated. Conversely, if the actual rotational speed increases, the correction variable may be generated and applied as described above, i.e., without a time offset.

For determining whether the mowing line is too short, at least one boundary condition may be checked. The at least one boundary condition may be an indication that the line mower is operating without load. Checking such a boundary condition allows for a more reliable determination of whether the mowing line is too short. The boundary condition may be a minimum value for the target rotational speed, a minimum value for the actual rotational speed, a minimum value for the power of the motor, and/or a maximum value for a change in the actual rotational speed. In this case, the change in the actual rotational speed may be determined by comparing it to an actual rotational speed that was determined before any of the aforementioned method steps were executed. If the actual rotational speed deviates from the previously determined actual rotational speed by more than the maximum value, it may be assumed that the line mower is in a state in which the actual rotational speed and the motor power are insufficient to reliably conclude that the mowing line is too short. This assumption may be made, for example, if the two rotational speeds differ by more than 200 min⁻¹, 500 min⁻¹,or 1000 min⁻¹. This way, transient response phases, for example, during power-on or start-up of the line mower, may be better taken into account. The same applies to the minimum value for the target rotational speed, the minimum value for the actual rotational speed, and the minimum value for the power of the motor. The minimum value for the target rotational speed may correspond to a position of the throttle lever described above.

Determining whether the mowing line is too short may be done, for example, using at least one reference parameter. The at least one reference parameter may be captured in the course of the method. For this purpose, for example, the at least one parameter may be stored in a memory of the line mower and loaded from there to determine whether the mowing line is too short. The at least one reference parameter may also be captured via an input field of the line mower. The at least one reference parameter may also be calculated by a control unit of the line mower to implement a mowing program, for example.

The at least one reference parameter may be, for example, the reference power described above. The at least one reference parameter may also represent a relationship between a rotational speed D and the reference power. For this purpose, the following formula may be employed, for example:

RefPow=a·(D−D₀)²+b.

wherein the variable RefPow represents the value of the reference power in W, for example. Parameters a, b, and D₀ may be determined by comparison with measured relationships between the actual rotational speed and the power of the motor and may also be stored in the memory or another memory of the line mower. Parameters a, b, and D₀ may also be considered reference parameters. In this case, the measured powers may be reduced by, for example, 5%, 10%, or 15% to disregard any negligible shortening of the mowing line when determining whether the mowing line is too short.

The reference power may be determined depending on the rotational speed using the formula described above, wherein the captured actual rotational speed may be equated to the rotational speed D and substituted into the formula. It should be noted in this case that the formula described above may, in many cases, represent a sufficient approximation for the relationship between rotational speed and reference power to reliably conclude that the mowing line is too short. It is conceivable in this case that other approximations or approximation formulas could also be used in the same way.

Multiple reference parameters may also be used, which represent a relationship between rotational speed and reference power, for example, as a sequence of rotational speed values, each being assigned a value of a reference power. Such a relationship may also be regarded as a representation of a characteristic curve. It is also conceivable to use multiple reference parameters that represent not just one, but several relationships or characteristic curves between rotational speed and reference power, with the relationships or characteristic curves being assigned to a specific length of the mowing line in each case. The reference power may thus be determined not only depending on the rotational speed, but also depending on the length of the mowing line. The length of the mowing line may be a target length, as described above, or it may be determined before the execution of one of the aforementioned method steps.

The relationships or characteristic curves mentioned may each represent a relationship between actual rotational speed and power, corresponding to an operation of the line mower without load. The powers associated with such operation may also be referred to as air power.

The at least one reference parameter may be stored not only in a memory of the line mower. The at least one reference parameter may be determined also in the course of a calibration step. For this purpose, the line mower may be placed into a calibration mode. In this mode, the line mower may be operated using a calibration power. The operation at the calibration power may last approximately 5, 10, 15, or 20 seconds, for example, or for a period of time sufficient so that any transient response of the mowing line during operation of the motor at the calibration power no longer significantly affects the actual rotational speed, at least at the end of the period of time. Following transient response of the line mower, the actual rotational speed may be captured during operation of the motor at the calibration power once. This actual rotational speed may be considered and employed as a reference parameter or calibration rotational speed and stored, for example, in a memory of the line mower.

The calibration rotational speed may be employed, for example, to select one of the aforementioned relationships between rotational speed and reference power. In this case, the relationship closest to the calibration rotational speed may be selected. Also, a new relationship may be generated by interpolation between the two closest relationships. It is also possible to adjust parameters a, b, and D₀ described above accordingly. In this case, parameters b and D₀ may be considered to be device-specific, so that only parameter a needs to be adjusted to the calibration rotational speed. It is also possible to select those relationships that are closest not only to the calibration rotational speed but also to the calibration power. Here, too, similar to the previously described characteristic curves, the value of the calibration power may be reduced by, for example, 5% or 10% to disregard any negligible shortening of the mowing line when determining whether the mowing line is too short.

The length of the mowing line during the calibration step may be employed in this way as a reference for determining whether the mowing line is too short. This allows the operator to adapt the method to their requirements. In particular, the mowing line may be exchanged and replaced with a mowing line featuring different rotational speed-power characteristics. Thus, the method may be adapted not only to different target lengths but also to a wide range of line types.

The calibration power may be a specific or maximum power at which the motor may be operated. The calibration power may also be half of the maximum power, or one-third or two-thirds of the maximum power. Using the maximum power as the calibration power may, in many cases, be employed to reduce the ratio of an error when determining the at least one reference parameter to the absolute value of the reference parameter. Thus, the determination of the reference parameter may be improved in terms of reliability.

The calibration step may be repeated several times. The reference parameters determined by repeating the calibration step several times can be used to determine the at least one reference parameter by means of averaging. It is also conceivable to disregard outliers in such averaging. In this way, it can be accounted for that the mowing line may have variations in its structure, in particular its composition, length and/or thickness, during calibration, which may at least slightly falsify the result. By repeating the calibration step followed by averaging, possibly by also omitting outliers, it is possible to prevent at least one reference parameter from being falsified by an unfavorable condition of the mowing line during the first or one of the subsequent calibration steps.

Repeating the calibration steps can be performed e.g. by adjusting the mowing line with each repetition and then cutting it to a certain length, e.g. the length corresponding to a full mowing circle. This can be done either manually or with the help of an automatic line adjustment mechanism. The line can be cut manually with a knife or with the help of a knife on the housing and/or a protective device, such as, e.g., a shield, of the line mower.

A length of the mowing line may also be calculated, and the length of the mowing line may be used to determine whether the mowing line is too short. The length may be determined, for example, using the actual rotational speed and the power and the aforementioned relationships, each of which is assigned to different lengths of the mowing line. This may, for example, be done by a comparison in which it is checked which relationship or parameter set best matches the actual rotational speed and the power of the motor. In this case, the comparison may be done, for example, in a two-dimensional Cartesian coordinate system. A point may be defined in the two-dimensional Cartesian coordinate system, which point is defined by the values of the actual rotational speed and the power of the motor. The reference parameters may be arranged in the same way in this system. The reference parameters closest to the point in this system may be used for the determination of the length of the mowing line. In this case, the closest relationship may be selected, or an interpolation may be performed between two or more relationships that are closest to the point. The latter may also be referred to as two-or multi-stage interpolation.

The length may also be calculated using an approximation formula:

MPow=c·(L−L₀)²+d.

wherein the variable MPow represents the value of the power in W, for example. Parameters c, d, and L₀ may be determined by comparison with measured relationships between length L of the mowing line and the power of the motor at a rotational speed D, and may also be stored in the memory or another memory of the line mower. Parameters c, d, and L₀ may also be considered reference parameters. Parameters c and d may depend on rotational speed D. This dependence may also be measured and stored accordingly in a memory of the line mower, or described using approximation formulas. A length L≥L₀ of the mowing line may therefore be assigned to the actual rotational speed and the power of the motor. The second solution of the approximation formula is often irrelevant and may be disregarded.

The target and/or actual rotational speed may be determined or captured by generating a moving average over several time steps. The power of the motor may also be generated using a moving average over several time steps or represent such an average. Using moving averages allows for the compensation of short-term outliers and fluctuations when capturing the actual rotational speed or the control of the power of the motor, and time discrepancies. As a result, the method may be even more improved in terms of reliability.

The moving averages may be generated over three, five, or ten time steps, for example. This may correspond to a period of time of 0.03 s, 0.05 s, and 0.1 s. The number of time steps may also be chosen differently. Also, ten time steps do not necessarily have to correspond to a period of time of 0.1 s. A period of time of 0.03 s or 0.01 s may also be divided into ten time steps.

The present disclosure also relates to a method for detecting a too-short mowing line of a line mower, wherein a method for detecting a too-short mowing line, as described above, is executed at a plurality of different points in time. In this case, it is checked whether, at a minimum number of the different points in time less than or equal to the plurality, it was detected that the mowing line is to too short. Dynamic or stochastic effects, such as short-term outliers and fluctuations when capturing the actual rotational speed or the control of the power of the motor, may thus be compensated for. Temporal discrepancies in capturing the actual rotational speed and the control of the power may be counteracted. As a result, the method may be improved in terms of reliability in this way also.

The different points in time may be distributed over a period of time of 0.1 s, 1 s, or 5 s. In this case, 10, 100, or 1000 points in time may be taken into account in each case. The different points in time may be arbitrarily spaced apart. They may also occur at regular intervals, for example at a rate of 10 Hz, 100 Hz, or 1000 Hz.

The result of the method may also be continuously updated. In this case, a new point in time may be added to the different points in time. To avoid having to retain an excessive number of values or data points, one of the different time points may also be replaced by the new point in time. In many cases, it is expedient to replace the earliest point in time with the new point in time and repeat the method.

Additionally, it may be checked whether, during the execution of one of the methods for detecting a too-short mowing line, a further condition is met at the plurality of different points in time. Furthermore, it may be checked whether, at a minimum number of the different points in time, it was detected that the mowing line is too short, and the further condition is met. The further condition may represent a check if the target rotational speed is less than or equal to the actual rotational speed. If, in the course of the methods for detecting a too-short mowing line, the length of the mowing line is determined or calculated at the plurality of different points in time, the further condition may be a check if the length of the mowing line is within a certain range, for example, whether the length of the mowing line is
less than 360 mm and greater than or equal to 340 mm;
less than 340 mm and greater than or equal to 320 mm;
less than 320 mm and greater than or equal to 300 mm;
less than 300 mm and greater than or equal to 280 mm;
less than 280 mm and greater than or equal to 250 mm;
less than 250 mm and greater than or equal to 220 mm;
less than 220 mm and greater than or equal to 180 mm; or
less than 180 mm and greater than or equal to 0 mm.

A too-short mowing line may be detected, for example, in that, at a plurality of 500 different points in time, the length of the mowing line fell within the range of less than 280 mm and greater than or equal to 250 mm at least 80 times. Instead of just one of these conditions, several of these conditions may be checked. If, for example, the length of the mowing line fell within the range of less than 250 mm and greater than or equal to 220 mm at least 80 times in the course of the aforementioned checks, the length of the mowing line is considered to fall in the range with the lower values and also detected to be too short. 200 or 1000 points in time may also be considered for this purpose. Also, the minimum number does not have to be 80, but may also be 30, 40, 50, or 100. Similarly, the boundaries of the aforementioned ranges may be chosen differently and adapted to the specific application scenario. It is also not necessary to define 8 different ranges. Two, three, five, ten, or 20 ranges may also be defined and used in the course of the proposed method. Also, the ranges do not need to be sharply delineated from one another. They may also overlap.

An additional example of the disclosure includes a control unit for a line mower configured to perform one of the methods described above. A further example of the disclosure includes a line mower designed to perform one of the methods described above.

Further features and aspects of the disclosure will become apparent from the following description, in which examples of the disclosure are described in detail using schematic drawings. It is understood that there are multiple other different ways to execute the invention. In the figures.

### BRIEF DESCRIPTION OF THE DRAWINGS

FIG. 1 shows a schematic representation of a string trimmer,

FIG. 2 shows a flow chart of a method according to an example of the disclosure.

### DETAILED DESCRIPTION

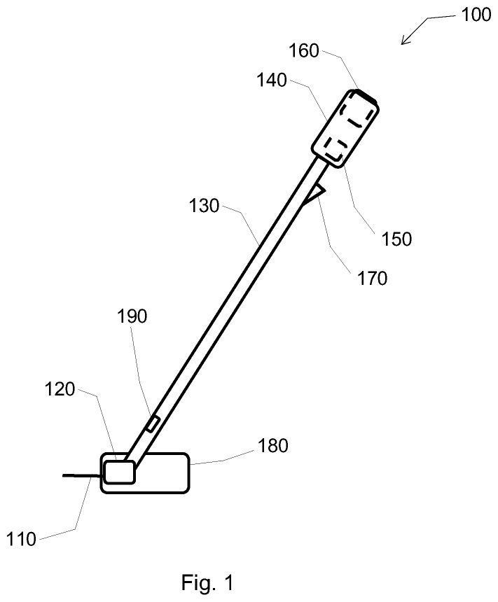

FIG. 1 shows a schematic representation of a string trimmer 100. String trimmer 100 is designed as a line mower having a mowing line 110. Mowing line 110 is set into rotation by an electric motor 120, and tightened by the rotation for forming a mowing circle for mowing or trimming grass or other vegetation. In this case, electric motor 120 rotates at the same rotational velocity or rotational speed as mowing line 110. Electric motor 120 is connected to a shaft 130. Shaft 130 is in turn connected to a housing 140. Housing 140 accommodates a control unit 150 and a battery pack 160. Battery pack 160 supplies electric motor 120 with electrical energy via shaft 130. Battery pack 160 is inserted into housing 140. Battery pack 160 is exchangeable and may be replaced with another, for example, structurally identical battery pack, as needed. Control unit 150 controls the electrical power consumption of electric motor 120. For this purpose, control unit 150 captures an actual rotational speed of electric motor 120. Control unit 150 is also connected to a control element 170. Using control element 170, an operator of string trimmer 100 may specify a target rotational speed. The target rotational speed is then determined by control unit 150 for controlling electric motor 120. For this purpose, control unit 150 compares the actual rotational speed of electric motor 120 with the captured or specified target rotational speed. The operator may also use control element 170 to specify whether string trimmer 100 is to be placed into a calibration mode, for example, after exchanging or changing mowing line 110. String trimmer 100 also features a guard 180. Guard 180 covers the mowing circle of mowing line 110 to one side and/or at least partially.

String trimmer 100 features an indicator 190 in shaft 130. Indicator 190 is designed as an LED indicator, which may be controlled by control unit 150 to indicate that mowing line 110 is too short. Instead of LED indicator 190, other output means, such as acoustic or other optical signals, may be used in other examples or further possible configurations of string trimmer 100. In this case, the output means may also be arranged in or on housing 140. String trimmer 100 is also equipped with a mechanism for automatic line feeding, which may be controlled by control unit 150 to adjust mowing line 110 as needed.

In other examples of string trimmer 100, an internal combustion engine may be utilized instead of electric motor 120. In this case, instead of battery pack 160, a corresponding tank and corresponding connecting lines for supplying the internal combustion engine with fuel may be provided, as well as further containers and connecting lines for supplying the internal combustion engine with further operating media.

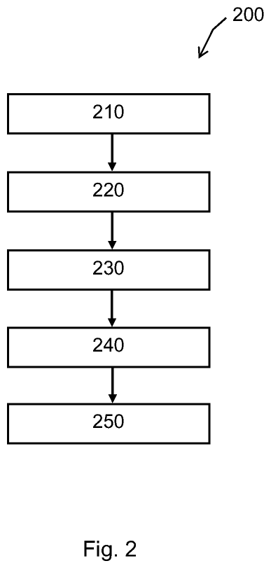

FIG. 2 shows a method 200 according to an example of the disclosure. Method 200 is executed by control unit 150 to detect whether mowing line 110 has become too short, for example, due to wear during operation of string trimmer 100 or due to contact with a sharp-edged obstacle. Method 200 starts with a step 210. In step 210, control unit 150 checks whether string trimmer 100 is to be placed into a calibration mode. For this purpose, control unit 150 checks whether an operator of string trimmer 100 has specified the placement into the calibration mode using control element 170. If the operator has set a corresponding signal, control unit 150 places string trimmer 100 into the calibration mode. In the calibration mode, electric motor 120 of string trimmer 100 is operated by control unit 150 at a maximum power of 600 W. The operation at the maximum power of 600 W lasts for approximately 5 seconds. This period of time is sufficient so that any transient response of mowing line 110 during operation of electric motor 120 at the maximum power no longer has a significant influence on the actual rotational speed of mowing line 110 or electric motor 120 at the end of the period of time of approximately 5 seconds. At the end of the period of time of approximately 5 seconds, the actual rotational speed of electric motor 120 is captured as a calibration rotational speed by control unit 150. If the calibration rotational speed is less than 4000 min⁻¹, control unit 150 detects an error and aborts the calibration. If the calibration rotational speed is greater than or equal to 4000 min⁻¹, control unit 150 employs the actual rotational speed to determine a parameter a using the following formula:

a=(Lmax−b)/(D−D₀)².

In this case, control unit 150 substitutes a value of 540 for variable Lmax (i.e., the value of the maximum power reduced by 10%), the value of the calibration rotational speed in min⁻¹ for parameter D, a value of 2000 for parameter D₀, and a value of 20 for parameter b in the formula. Parameters D₀ and b are device-specific and may feature different values in other examples of method 200 or string trimmer 100. The values for parameters D₀ and b are stored in a memory of control unit 150. Parameter a determined in this way is then also stored by control unit 150 as a reference parameter in the memory of control unit 150 to be employed in the subsequent steps of method 200 to detect whether mowing line 110 features the correct length or whether mowing line 110 has become too short. Reducing the value of variable Lmax to 540 makes it possible to disregard any negligible shortening of the mowing line.

If the operator has not set a corresponding signal to place string trimmer 100 into the calibration mode, or if the calibration has been aborted by control unit 150, control unit 150 places a marker variable in step 210. The marker variable then controls whether a too-short mowing line 110 is detected based on a plurality of characteristic curves between rotational speed and reference power stored in the memory of string trimmer 100 for a recommended mowing line type, or using parameter a determined during calibration and the values for D₀ and b stored in the memory of control unit 150, and the relationship.

RefPow=a·(D−D₀)²+b.

wherein the variable RefPow represents the value of the reference power in W.

Thereafter, after step 210, method 200 continues with step 220. In step 220, control unit 150 checks the target rotational speed at which electric motor 120 of string trimmer 100 is to be operated. For this purpose, control unit 150 captures a position of operating element 170 and, as a result, also the target rotational speed specified by the operator using operating element 170.

After the target rotational speed has been captured in step 220, method 200 continues with step 230. In step 230, a power of electric motor 120 is controlled to set mowing line 110 into rotation for mowing with the target rotational speed and to tighten it for forming a mowing circle. In this case, the power of electric motor 120 is controlled using a rotational speed-power characteristic, which is also stored in the memory of control unit 150. The rotational speed-power characteristic allows a power of electric motor 120 to be assigned to each target rotational speed. In this case, the actual rotational speed of electric motor 120 is also captured by control unit 150, and the power is adjusted so that the actual rotational speed reaches the target rotational speed. In this case, the actual rotational speed is captured by generating a moving average over several time steps.

Step 240 follows the adjustment of the power in step 230. In step 240, control unit 150 determines whether mowing line 110 is too short. For this purpose, control unit 150 first checks boundary conditions, each of which indicates that string trimmer 100 is operating without load. These boundary conditions include a minimum value for the target rotational speed and a minimum value for the actual rotational speed, wherein it is checked in the present case, whether these quantities are greater than 4000 min⁻¹ or equal to 4000 min⁻¹ in each case. It is also checked whether the power or power consumption of electric motor 120 is greater than or equal to 15 W and whether the actual rotational speed has not changed by more than a maximum value corresponding to 1000 min⁻¹ compared to a value for the actual rotational speed previously stored in the memory described above. In this case, the value for the actual rotational speed stored in the memory is set to the value of 6000 during the first performance of method 200 and updated after step 240 is completed. If the actual rotational speed deviates from the previously determined actual rotational speed by more than the maximum value, it may be assumed that string trimmer 100 is in a state where the actual rotational speed and the power of electric motor 120 are insufficient to reliably conclude that mowing line 110 is too short. Transient response phases, for example, during power-on and start-up of string trimmer 100, may be taken into account in this way. The same applies to the minimum value of the target rotational speed, the minimum value of the actual rotational speed, and the minimum value for the power of the motor. The minimum value for the target rotational speed may correspond to a position of control element 170 described above.

If the boundary condition check reveals that string trimmer 100 is not in a state without load, i.e., if control unit 150 determines that one of the aforementioned boundary conditions is not met, step 240 is aborted at this point, and method 200 continues with step 250, which is explained in more detail below. If the result of the aforementioned check is positive, control unit 150 thereafter checks whether an overshoot of the actual rotational speed is to be taken into account. For this purpose, control unit 150 checks whether the actual rotational speed is more than 200 min⁻¹ above the target rotational speed. In other examples of method 200, control unit 150 may check at this point whether the actual rotational speed is 500 min⁻¹ or 1000 min⁻¹ above the target rotational speed, or whether it exceeds the target rotational speed by more than 5%, 10%, or 15% of the actual or target rotational speed, or is merely greater than the target rotational speed. If it is determined in this case that the deviation of the actual rotational speed from the target rotational speed is too large, it is determined that the available data cannot reliably detect whether mowing line 110 is too short. In this case, step 240 is aborted at this point, and method 200 continues with step 250 (see below).

If the result of the aforementioned overshoot check is negative, i.e., the actual rotational speed is less than 200 min⁻¹ above the target rotational speed or is less than or equal to the target rotational speed, the target rotational speed captured in step 220, the actual rotational speed captured by control unit 150 in step 230, and the power of electric motor 120 adjusted in step 230 are thereafter employed to detect whether the mowing line 110 is too short. Also, control unit 150 checks the marker variable set in step 210. If the marker variable indicates that a too-short mowing line 110 is to be detected using parameter a determined during calibration, values for D₀ and b stored in the memory, and the relationship

RefPow=a·(D−D₀)²+b,

the actual rotational speed detected in step 230 is substituted into this relationship by control unit 150 and checked whether the resulting reference power is less than or equal to the power of electric motor 120 adjusted in step 230. If this is the case, control unit 150 determines that mowing line 110 is too short.

If the marker variable indicates that a too-short mowing line 110 is to be detected using the plurality of characteristic curves stored in memory, control unit 240 uses the plurality of characteristic curves to determine whether mowing line 110 has become too short. Each characteristic curves represents a relationship between rotational speed and reference power, each of which is stored in the memory of string trimmer 100 as a sequence of rotational speed values, each of which is assigned a value of a reference power. Also, each characteristic curve is assigned a length of mowing line 110, allowing the length of mowing line 110 to be determined and whether the mowing line is too short using the characteristic curves. In this case, the length is determined by a comparison in which it is checked which two characteristic curves best match the actual rotational speed and the power of the motor. The comparison is done in a two-dimensional Cartesian coordinate system, in which one point is defined whose position within the two-dimensional Cartesian coordinate system is determined by the actual rotational speed and the power of the motor. The characteristic curves, or sequence of rotational speed values, each of which is assigned a value of a reference power, are arranged in this plane in the same way. The two characteristic curves closest to the point defined by the actual rotational speed and the power of motor 120 are employed to determine the length of the mowing line. In this case, an interpolation is performed between the two closest characteristic curves; i.e., the length of the mowing line is determined by a weighted averaging the lengths assigned to the two closest characteristic curves. In this case, the distance of the point from the two characteristic curves is factored into the weighting of the weighted averaging. If the point is located exactly on one of the two characteristic curves, mowing line 110 is determined to have the length assigned to that characteristic curve. If the point is located exactly between two characteristic curves, the length of the mowing line is determined by the arithmetic mean of the two lengths assigned to the two characteristic curves.

In other examples of method 200, the length of mowing line 110 may be calculated using an approximation formula:

MPow=c·(L−L₀)²+d,

wherein the variable MPow represents the value of the power of electric motor 120, adjusted in step 230, in W, for example. Parameters c, d, and L₀ may be determined by comparison with measured relationships between length L of the mowing line and the power of the motor at a rotational speed D and may also be stored in the memory of control unit 150 of string trimmer 100. Parameters c, d, and L₀ may also be considered reference parameters. Parameters c and d may depend on rotational speed D. This dependence may also be measured and stored accordingly in the memory of control unit 150 of line mower 100, or described using approximation formulas. A length L≥L₀ of the mowing line may therefore be assigned to the actual rotational speed and the power of the motor. The second solution of the approximation formula is often irrelevant and may therefore be disregarded.

In further examples of method 200, a correction variable may be generated by control unit 150 using the target and actual rotational speeds. The correction variable may depend on the difference between the target and actual rotational speeds as already described. In this case, the length of mowing line 110 may also be taken into account. For this purpose, the length of mowing line 110 may be determined as described above, and the correction variable may additionally be generated using the length of the mowing line 110. The power of electric motor 120 may then be corrected by control unit 150 using the correction variable to determine whether mowing line 110 is too short. In particular, the drop in power during overshoot may be compensated for by the correction variable; i. e, the power may be corrected towards higher powers using the correction variable when determining whether mowing line 110 is too short. Similarly, one or more of the reference powers described above may be reduced using the correction variable to prevent the erroneous determination that mowing line 110 is too short. In this case, the correction variable may be a correction power, wherein the correction power is added to the power of electric motor 120 or subtracted from the one or more reference powers. Also, the correction variable may be a dimensionless factor by which the power of electric motor 120 or the one or more reference powers is/are multiplied.

Also, in these examples of method 200, a change in the actual rotational speed may additionally be captured and the change may be taken into account when generating the correction variable and/or correcting the power. If, for example, the actual rotational speed decreases, the correction variable may be generated using previous values for the actual rotational speed and the power of the motor. Similarly, a correction variable applied at an earlier point in time may still be employed. For example, the correction variable generated approximately 0.1 s, 0.08 s, or 0.05 s ago may still be applied. Such a time offset may prevent the correction of the power of the motor or the reference power from being prematurely terminated. Conversely, if the actual rotational speed increases, the correction variable may be generated and applied as described above, i.e., without time offset.

In step 250, control unit 150 stores the results of step 240 in the memory. If method 200 was not aborted in step 240 and the marker variable indicates that a too-short mowing line 110 is to be detected using the plurality of characteristic curves stored in the memory, the length of mowing line 110 determined immediately beforehand in step 240 is included in the results recorded or stored in the memory in step 250. This is done by control unit 150 checking whether the length of the mowing line is
less than 360 mm and greater than or equal to 340 mm;
less than 340 mm and greater than or equal to 320 mm;
less than 320 mm and greater than or equal to 300 mm;
less than 300 mm and greater than or equal to 280 mm;
less than 280 mm and greater than or equal to 250 mm;
less than 250 mm and greater than or equal to 220 mm;
less than 220 mm and greater than or equal to 180 mm; or
less than 180 mm and greater than or equal to 0 mm.

In this case, each of these ranges is assigned a range count variable, which is incremented by 1 if it matches the length of the mowing line. In this case, during the first execution of step 250, all range count variables assume the value of 0. If method 200 was not aborted in step 240 and the marker variable indicates that a too-short mowing line 110 is to be detected using parameter a determined during calibration, the values for D₀ and b stored in memory, and the relationship

RefPow=a·(D−D₀)²+b,

the range count variable for the range with the shortest lengths is incremented by 1 if it is determined in step 240 that mowing line 110 is too short, and the range count variable for the range with the greatest lengths is incremented by 1 if it is determined in step 240 that mowing line 110 is not too short. The range count variable for the range with the shortest lengths is also incremented by 1 if method 200 was aborted in step 240. This also applies to the case in which the length of mowing line 110 could not be classified into any of the mentioned ranges.

Thereafter, the control unit increments an execution count variable by 1. This execution count variable is set to a value of 0 during the first execution of step 250. Thereafter, the control unit checks whether the execution count variable is greater than or equal to 500. If the value of the execution count variable is less than 500, the control unit continues method 200 with step 220. If the execution count variable assumes a value of greater than or equal to 500, control unit 150 checks which of the range count variables assumes a value of greater than or equal to 80. If none of the range count variables assigned to a range less than 300 mm assumes a value of greater than or equal to 80, control unit 150 determines that mowing line 110 is not too short. If one of the range count variables assigned to a range less than 300 mm assumes a value of greater than or equal to 80, control unit 150 determines that mowing line 110 is too short. If control unit 150 has determined that the mowing line is too short, control unit 150 sends a corresponding signal to the LED indicator 190 to indicate to the operator of string trimmer 100 that mowing line 110 is too short.

Also, in step 250, it is recorded which of the range count variables was incremented by 1. For this purpose, a register is populated with an identifier for the range variable that was incremented by 1, and the execution count variable. The register retains 500 of these value pairs. Once the register is filled with 500 value pairs, the pair with the lowest value of the execution variable is replaced by the previously described value pair. Also, the control unit thereafter decrements the range count variable corresponding to the lowest value of the execution variable in the register by 1. Thereafter, method 200 continues with step 220.

What is claimed is:

1. A method for detecting a too-short mowing line of a line mower, comprising the steps of:
at a plurality of different points in time,
controlling a power of a motor of the line mower to set the mowing line into rotation for mowing and to tighten it by the rotation;
capturing an actual rotational speed; and
determining, using the actual rotational speed and the power of the motor whether the mowing line is too short;
thereafter checking whether, at a first minimum number of the different points in time, it was detected that the mowing line is too short;
wherein the first minimum number is less than or equal to the plurality of different points in time.

2. The method according to claim 1, further comprising:
checking whether a further condition is met at the plurality of different points in time; and
checking whether at a second minimum number of the different points in time it was detected that the mowing line is too short, and the further condition is met.

3. The method according to claim 1, further comprising:
checking a boundary condition to determine whether the mowing line is too short;
wherein the boundary condition is at least one of:
a minimum value for a target rotational speed;
a minimum value for the actual rotational speed;
a minimum value for the power of the motor; or
a maximum value for a change in the actual rotational speed.

4. The method according to claim 1, further comprising:
determining a length of the mowing line; and
wherein the length of the mowing line is used to determine whether the mowing line is too short.

5. The method according to claim 1, further comprising at least one of:
generating the actual rotational speed using a moving average over several time steps; or
generating the power using a moving average over several time steps.

6. A line mower configured to perform the method according to claim 1.

7. A method for detecting a too-short mowing line of a line mower, comprising the steps of:
capturing a target rotational speed;
controlling a power of a motor of the line mower to set the mowing line into rotation for mowing and to tighten it by the rotation;
capturing an actual rotational speed;
using the target rotational speed, the actual rotational speed and the power of the motor to determine whether the mowing line is too short.

8. The method according to claim 7, further comprising:
generating a correction variable using the target rotational speed and the actual rotational speed; and
correcting the power towards higher powers using the correction variable to determine whether the mowing line is too short.

9. The method according to claim 8, further comprising:
capturing a length of the mowing line; and
generating the correction variable additionally using the length of the mowing line.

10. The method according to claim 8, further comprising:
capturing a change in the actual rotational speed and
at least one of generating the correction variable, or correcting the power is based on the change in the actual rotational speed.

11. The method according to claim 7, further comprising:
checking a boundary condition to determine whether the mowing line is too short,
wherein the boundary condition is at least one of:
a minimum value for the target rotational speed;
a minimum value for the actual rotational speed;
a minimum value for the power of the motor; or
a maximum value for a change in the actual rotational speed.

12. The method according to claim 7, further comprising:
determining a length of the mowing line; and
determining whether the mowing line is too short based on the length of the mowing line.

13. The method according to claim 7, further comprising at least one of:
generating the actual rotational speed using a moving average over several time steps;
generating the power using a moving average over several time steps; or
generating the target rotational speed using a moving average over several time steps.

14. A line mower configured to perform the method according to claim 7.

15. A method for detecting a too-short mowing line of a line mower, comprising the steps of:
capturing at least one reference parameter;
controlling a power of a motor of the line mower to set the mowing line into rotation for mowing and to tighten it by the rotation;
capturing an actual rotational speed;
determining, using the at least one reference parameter, the actual rotational speed and the power of the motor, whether the mowing line is too short.

16. The method according to claim 15, further comprising:
determining, in the course of a calibration step, the at least one reference parameter.

17. The method according to claim 16, further comprising:
operating the motor with a calibration power in the course of the calibration step;
capturing a calibration rotational speed when the motor is operated with the calibration power; and
determining the at least one reference parameter using the calibration rotational speed.

18. The method according to claim 15, further comprising:
checking a boundary condition to determine whether the mowing line is too short,
wherein the boundary condition is at least one of:
a minimum value for a target rotational speed;
a minimum value for the actual rotational speed;
a minimum value for the power of the motor; or
a maximum value for a change in the actual rotational speed.

19. The method according to claim 15, further comprising at least one of:
generating the actual rotational speed using a moving average over several time steps;
generating the power using a moving average over several time steps; or
generating a target rotational speed using a moving average over several time steps.

20. A line mower configured to perform the method according to claim 15.
